(19) United States
(12) Patent Application Publication
(10) Pub. No.: US 2023/0349593 A1
(43) Pub. Date: Nov. 2, 2023

(54) ENERGY METER APPARATUS

(71) Applicant: HBX CONTROL SYSTEMS INC., Calgary (CA)

(72) Inventors: Curtis BENNETT, Calgary (CA); Tom HERMANN, Millerville (CA)

(73) Assignee: HBX CONTROL SYSTEMS INC., Calgary (CA)

(21) Appl. No.: 17/625,992

(22) PCT Filed: Jul. 10, 2020
(86) PCT No.: PCT/CA2020/050958

§ 371 Date: Jan. 10, 2022

Related U.S. Application Data
(60) Provisional application No. 62/872,614, filed on Jul. 10, 2019.

(51) Int. Cl. F24H 15/148; G01K 17/16

(52) U.S. Cl. CPC F24H 15/148; G01K 17/16

(57) ABSTRACT

An energy meter apparatus includes a sensing unit including a first temperature sensor configured to measure temperature of the fluid at a first boundary of the system and a processing-reporting unit comprising a second temperature sensor configured to measure temperature of the fluid at a second boundary of the system. One or both of a flow sensor and a pressure sensor is included in one of the sensing unit and the processing-reporting unit, and the pressure sensor is included in one of the sensing units and the processing-reporting unit. The processing-reporting unit is configured to establish and maintain a first wireless communication channel for communication with the sensing unit. The sensing unit is configured to report sensor measurements to the processing-reporting unit via the wireless communication channel.

### CROSS-REFERENCE TO RELATED APPLICATIONS

This application claims the benefit of priority to U.S. Patent Application Ser. No. 62/872,614 entitled “HEAT METER APPARATUS” filed Jul. 10, 2019, which is hereby incorporated by reference in its entirety.

### FIELD OF THE INVENTION

The present invention pertains to the field of measuring thermal energy, flow rate, pressure and temperature of a fluid that is transferred to or from a system.

### BACKGROUND

In view of rising energy costs, energy metering is required to determine the extent of the actual use thereof. Certified metering systems are required to comply with very stringent approval parameters that include the distance that a sensor can be from a return sensor or calculator, and the type of flow sensing that is being used.

Currently used metering systems use cables or wires for communication between sensors and processors or calculators. The distance requirement between sensors and a calculator presents a big issue in current energy meters, as the standard does not allow for changes in the length of the cables for the supply and return sensors. In many cases, the cable is simply too short to be properly installed at a location.

An energy meter must sense the temperature on the supply and return fluid (such as water) for each system, suite, or space it is metering. Most times the supply and return pipes are not close to each other, and such meters cannot be accommodated without re-piping a system, which may not be possible in many situations.

The cable length of a sensor depends on the physical size (diameter, cross-section, or AWG) of the wire and most metering units/systems use the smallest cross section possible. The cable length is often specified by industry standards and may not be modified. Commonly used cable lengths include 3 m and 15 m.

The energy used by a fluid heating or cooling system may be measured by measuring the temperature at the boundaries of the system; at the fluid inlet and at the fluid outlet, and by measuring the flow rate of the fluid through the system. Additional accuracy may be obtained by also measuring the fluid pressure within the system.

In addition, the certification requirements do not allow cutting or splicing the wires or cables. This makes it difficult to increase the distance between components that are wired together in order to pass the cable through walls or other equipment.

Therefore, there is a need for a metering system that overcomes one or more limitations of the prior art.

This background information is provided for the purpose of making known information believed by the applicant to be of possible relevance to the present invention. No admission is necessarily intended, nor should be construed, that any of the preceding information constitutes prior art against the present invention.

### SUMMARY

An object of the present invention is to provide an energy metering apparatus and system.

In accordance with an aspect of the present invention, there is provided an energy meter apparatus for measuring energy use in a system having a fluid circulating there through. The apparatus includes a sensing unit including a first temperature sensor configured to measure temperature of the fluid at a first boundary of the system, a processing-reporting unit including a second sensor configured to measure temperature of the fluid at a second boundary of the system, and one or both of a flow sensor and a pressure sensor. The flow sensor is configured to measure an amount of the fluid through the system and is included in one of the sensing unit and the processing-reporting unit. The pressure sensor is configured to measure a pressure of the fluid flowing through the system and is included in one of the sensing unit and the processing-reporting unit. The processing-reporting unit is configured to establish and maintain a first communication channel for communication with the sensing unit. The sensing unit is configured to report sensor measurements to the processing-reporting unit via the first communication channel. These units can also be configured in standalone, where only one unit is used to report on temperature and flow or temperature and pressure, or in some cases temperature pressure and flow. These can be used in a supplemental configuration with a single external temperature sensor added for the supply temperature.

This provides the technical benefit of allowing the sensing unit and the processing-reporting unit to be installed at an arbitrary distance from each other.

In further embodiments, the processing-reporting unit hosts a sensor network accessible by the sensing unit where the first communication channel is established over the sensor network. This provides the technical benefit of creating a secure private network for the sensing unit and the processing-reporting unit.

In further embodiments, the sensing unit includes the pressure sensor, and the processing-reporting unit comprises the flow sensor.

In further embodiments, the sensing unit, or the processing-reporting unit, are configured to store a predetermined amount of measurement data in internal memory for later retrieval. This allows for data to be captured and stored even when the processing-reporting unit is disconnected from an external server.

In further embodiments, the processing-reporting unit is configured to store a predetermined amount of measurement data in internal memory for later retrieval.

In further embodiments, the processing-reporting unit is configured to communicate, via a second communication channel separate from the first communication channel with an external server or a mobile device.

In further embodiments, the second communication channel is established and maintained by a device separate from the processing-reporting unit.

In further embodiments, the first or the second communication channels operate over wireless network according to a Wi-Fi protocol, a digital wireless communication protocol, a Bluetooth™ protocol, a Zigbee™ protocol, or a mobile telephony protocol. The provides the technical benefit of enabling the flexible placement and installation of the processing-reporting unit and the sensing unit.

In further embodiments, the first or second communication channel allows for concurrent communication by or with two or more sensors or devices at a time.

In further embodiments, the sensing unit and the processing-reporting unit are configured to communicate via the first communication channel when the sensing unit and the processing-reporting unit are a predetermined distance apart.

In further embodiments, the sensing unit and the processing-reporting unit are configured to communicate via the first wireless channel at least when the sensing unit and the processing-reporting unit are any distance apart.

In further embodiments, the system further includes a server configured to communicate directly or indirectly with the processing-reporting unit to receive energy usage data therefrom.

In further embodiments, the server is further configured to provide energy usage data to a second computer system configured to generate billing information based on the energy usage data, or the server is further configured to generate the billing information based on the energy usage data.

In further embodiments, the server is further configured to provide one or both of usage data and billing information to a consumer mobile device having an application thereon which, when operated, displays said energy usage data, billing information, or both.

In further embodiments, the application, when operated, further causes the consumer mobile device to communicate with the apparatus to receive the energy usage data directly therefrom.

In accordance with another aspect of the invention, there is provided a system including the apparatus as described herein, and a server configured to communicate directly or indirectly with the apparatus to receive energy usage data therefrom, or a consumer mobile wireless device having an application thereon which, when operated, configures the consumer mobile device to wirelessly communicate with the apparatus to receive energy usage data therefrom.

### BRIEF DESCRIPTION OF THE FIGURES

The invention will now be described by way of an exemplary embodiment with reference to the accompanying simplified, diagrammatic, not-to-scale drawings.

In the drawings:

FIG. 1 depicts a system comprising a metering apparatus in accordance with an embodiment of the present invention.

FIG. 2 illustrated a method of connecting a processing-reporting unit to a building network and to a sensing unit in accordance with an embodiment of the invention.

FIG. 3 illustrates a block diagram of a computing device that may be used or customized to implement networked processing-reporting unit or a sensing unit in accordance with an embodiment of the invention.

It will be noted that throughout the appended drawings, like features are identified by like reference numerals.

### DETAILED DESCRIPTION

Unless defined otherwise, all technical and scientific terms used herein have the same meaning as commonly understood by one of ordinary skill in the art to which this invention belongs.

Embodiments of the present invention provides an energy metering apparatus and system, which obviates the problems related to physically connecting different sensor components via cables, such as when sensors must be placed further apart than the cable length and the cable length may not be altered. The apparatus and system of embodiments also provides real time accuracy and data transmission, along with real time access to current and historical data from the sensors.

In an aspect, the embodiments provide an energy meter apparatus for measuring energy use in a system having a fluid circulating within. The apparatus comprises a sensing unit including a first temperature sensor configured to measure the temperature of the fluid at boundaries of the system, such as upon entering the system or exiting the system, and a processing-reporting unit including a second temperature sensor configured to measure the temperature of the fluid at an opposing boundary of the system, such as upon entering the system or exiting the system. The apparatus is also provided with one or both of a flow sensor and a pressure sensor. The flow sensor is configured to measure an amount or rate of flow of the fluid through the system and may be included in one of the sensing unit or the processing-reporting unit. The pressure sensor is configured to measure the pressure of the fluid flowing through the system and is included in one of the sensing unit or the processing-reporting unit. As the fluid flows through the system from the fluid inlet to the fluid outlet, the temperature of the fluid drops. In an embodiment, a temperature sensor at the warmer, inlet of the system may also include a pressure or flow sensor. A temperature sensor at the cooler, outlet of the system may also include a flow or pressure sensor.

The processing-reporting unit is configured to establish and maintain a first communication channel for communication with the sensing unit, and the sensing unit is configured to report sensor measurements to the processing-reporting unit via the first communication channel.

In embodiments, the circulating fluid can be water, glycol, methanol, or similar fluids.

In some embodiments, the processing-reporting unit hosts an ad hoc network accessible by the sensing unit.

In some embodiments, the sensing unit comprises the pressure sensor, and the processing-reporting unit comprises the flow sensor.

In some embodiments, the sensing unit or the processing-reporting unit are configured to store a predetermined amount of measurement data in internal memory for later retrieval. Preferably, the processing-reporting unit is configured to store a predetermined amount of measurement data in internal memory for later retrieval.

In some embodiments, the processing-reporting unit is configured to communicate, via a second communication channel separate from the first wireless communication channel or via a wired communication link, with an external server or mobile device.

In some embodiments, the second wireless communication channel or network is established and maintained by a device that separate from the processing-reporting unit. This device may be a Wi-Fi router, computer, or other electronic device with a wireless networking device for hosting a wireless network, cellular tower, etc.

In some embodiments, the first or the second wireless communication channel operates according to a Wi-Fi protocol, a digital wireless communication protocol, a Bluetooth™ protocol, a Zigbee™ protocol, or a mobile telephony protocol. The first and second wireless communication channels may be selected for desired inter-device compatibility, signal strength in the target environment, power limitations, and the like, or a combination thereof.

In some embodiments, the first or second wireless communication channel allows for concurrent communication by or with two or more sensors or devices at a time. Preferably, the second wireless communication channel allows for concurrent communication by or with two or more sensors or devices at a time.

In some embodiments, the sensing unit, and the processing-reporting unit are configured to communicate via the first channel at least when the units are any distance apart.

In some embodiments, the sensing unit, and the processing-reporting unit are configured to communicate via the sensor network at least when the units are placed more than a distance used by prior, wired energy meters, which are commonly connected by wires 3 m or 15 m long. Embodiments allow for the sensing unit and the processing-reporting unit to be places and arbitrary distance apart and when the units are connected by a wireless network, there is additional flexibility in the placement of the units since a wire or cable does not have to be installed between.

In another aspect, embodiments of the present invention provide a system comprising the metering apparatus as described herein, and a server configured to communicate directly or indirectly with the apparatus to receive energy usage data therefrom.

In some embodiments, the server is further configured to generate billing information based on said energy usage data.

In some embodiments, the server is further configured to provide energy usage data to another computer system, and the other computer system is configured to generate billing information based on the energy usage data.

In some embodiments, the server is further configured to provide usage data, or billing information to a consumer mobile wireless device having an application thereon which, when operated, displays the energy usage data, billing information, or both. In some embodiments, the application, when operated, further causes the consumer mobile device to wirelessly communicate with the apparatus to receive the energy usage data directly therefrom.

In another aspect, the present invention provides a system comprising the metering apparatus as described herein, and a consumer mobile wireless device having an application thereon which, when operated, configures the consumer mobile device to wirelessly communicate with the apparatus to receive energy usage data therefrom.

Embodiments provide an improved metering apparatus which collects temperature, flow, and pressure data in the same system.

The present apparatus is configured such that the processing-reporting unit (i.e. primary sensor) and the sensing unit (secondary sensor) communicate with each other via a communication channel (such as Wi-Fi network) created by the processing-reporting unit, and the sensing unit communicates on that network only. The processing-reporting unit also creates a communication channel over a second wireless network with an external server, or mobile wireless device (via an app).

This configuration of the primary and secondary sensors enables the apparatus to transmit data to the server at certain time intervals and has a real time logging feature. The primary sensor can be set, remotely to upload its data every 5 seconds to the server. The frequency that data is sent to the server is application specific and may be varied for each installation or use.

The processing-reporting unit (primary sensor) in a standard configuration can save data for up to 1 year, 12 monthly usage numbers, 31 days of the currently usage in that month on a daily basis, the hourly usage in the past 24 hours as well as the 7 day usage, which cannot be achieved with other meters or apparatus currently available. By increasing the internal storage of the processing-reporting unit, other configurations may save data for even longer times. This data may also be stored on the remote communication server for a longer period of time.

The previously known metering units only report a total accumulated usage over time, which may not be resettable. According to embodiments of the present invention, an additional user resettable accumulated usage can also be recorded and reported. This allows for more flexibility in usage logging, without requiring external recording of prior readings and mathematical operations to determine usage between measurement intervals.

In some embodiments, the processing-reporting unit, the sensing unit, or both, may include one or more controllable actuators, such as triacs, relays, controllable switches, level-controllable electrical outputs, etc. These outputs may be controlled remotely via user commands or automatically according to internal routines (based on monitored conditions) to actuate external devices such as alarms, fire, or flood control devices, etc.

In various embodiments, the server, which is remotely connected to the heat meter apparatus, may be configured through an application programming interface (API). This API can be used in computer programs to interact with other computer systems. For example, the API may allow other systems to request and receive heat metering or billing data stored by the server.

The apparatus of the present invention provides accurate calculations in glycol, methanol, and water at any concentration to a maximum flow as dictated by the capabilities of the flow sensor used in the system. Some common flow sensors have a maximum flow rate of 105 GPM.

To gain a better understanding of embodiments described herein, the following examples are set forth. It will be understood that these examples are intended to describe illustrative embodiments of the invention and are not intended to limit the scope of the invention in any way.

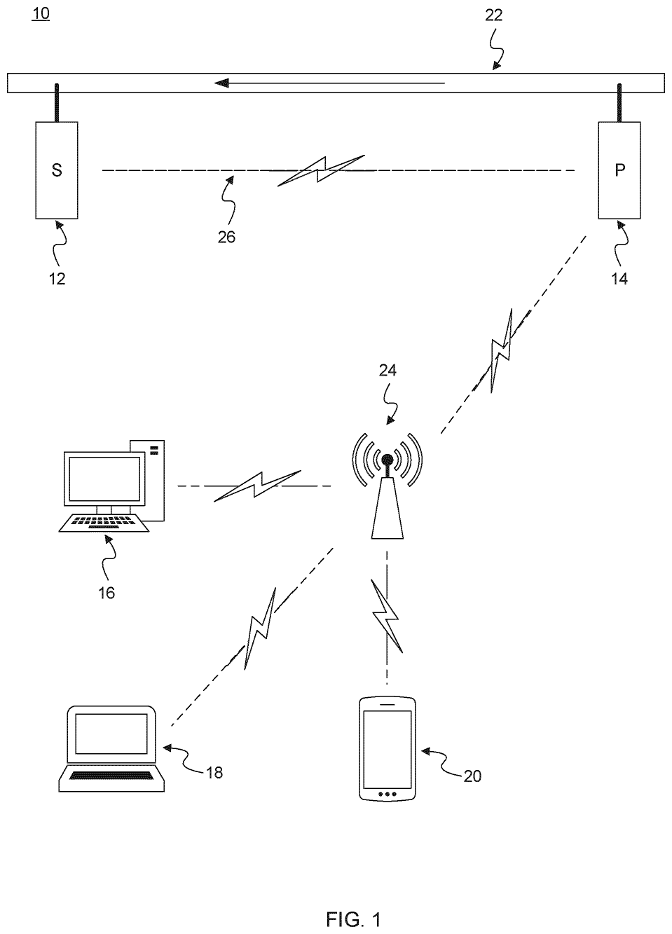

FIG. 1 is a schematic depiction of an example of a system 10 including a metering apparatus in accordance with an embodiment. The system 10 is used to measure the energy use or loss as a fluid 22 flows through. The system includes a sensing unit (i.e. secondary sensor) 12 configured to communicate with a processing-reporting unit (i.e. primary sensor) 14 only via a wired or wireless sensor network 26 created by the processing-reporting unit 14. In embodiments, the sensor network 26 may be implemented as a wireless network such as a Wi-Fi. The processing-reporting unit is further configured to connect to an existing second communication network 24 (such as a local Wi-Fi network) to an external server 16, or with a mobile wireless device 20 (via an app). The local network 24 may be provided in an area where the system is deployed such as a building, campus, etc. The local network 24 may be a wired network such as Ethernet, a wireless network such as Wi-Fi, or another network as is known in the art. In this embodiment, the sensing unit 12 is equipped with pressure and temperature sensors, and the processing-reporting unit 14 is equipped with flow and temperature sensors. The sensing unit 12 and the processing-reporting unit 14 are installed to monitor the temperature of the fluid 22 at boundaries of the system such as at an inlet and an outlet.

In order to conduct energy metering for a water supply coming from an energy source, temperature measurements for the water entering the area or system are obtained via the secondary sensor in sensing unit 12, and the return water temperature after the energy has been absorbed by the system being implemented is obtained via the primary sensor in processing-reporting unit 14, and the difference in temperature over a period of time (ΔT) is calculated. Energy calculations may be performed by the processing-reporting unit 14 with results being reported in units of energy (such as BTU) or units of volume. The processing-reporting unit 14 includes sufficient internal storage to hold sensor and energy data for a sufficient period of time so that data is not lost when local network 24 becomes unavailable. Data may be collected and stored based on a real time basis or on an hourly, daily, weekly, monthly periods. In embodiments, pressure and flow rate are measured, (instead of just flow rate as done with convention systems), to achieve accurate calculations in different fluids such as water, glycol, and methanol at any concentration and at any flow rate.

The sensor network 26 between the processing-reporting unit 14 and the sensing unit 12, allows the calculator in the processing-reporting unit 14, to receive secondary sensor information over sensor network 26 from sensing unit 12 to complete the energy calculation. In addition, a separate communication between the processing-reporting unit 14 and an external server 16, allows us to simultaneously communicate between sensors as well as uploading of the real time data to the server 16. The sensing unit 12 and the processing-reporting unit 14 are not limited by wire length to communicate with the calculator. Detailed data is available and may be displayed continuously during the calculating process.

In some embodiments, the sensing unit 12 or the processing-reporting unit 14 may be configured to provide a triac output for the ability to operate valves or pumps based on flow, temperature, and pressure trigger limits selected by the user for system balancing and preventative system failure.

Once the server 16 receives the data the app installed in mobile device 20 is able to communicate directly with the server and log, in real time or view historical data that was collected by the sensor in processing-reporting unit 14 and the sensor in sensing unit 12. The app also provides the ability for the user to connect to the unit to retrieve information through a local connection (on-site) if there is not a wireless network available, which can be important for billing purposes.

In this embodiment, the server 16 is further configured to provide energy usage data to another computer system 18, which in turn is configured to generate billing information based on the energy usage data. In the case where multiple energy meter apparatus are installed in a single location, such as in units of an office building or apartment, computer system 18 can be used to provide energy use data for individual units or groups of units that each contain an energy meter apparatus.

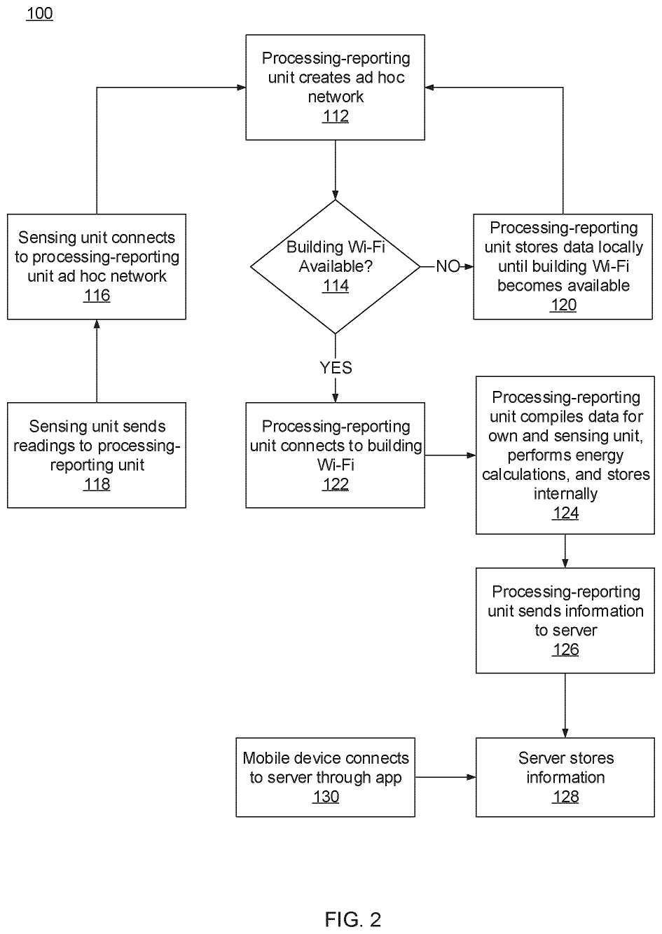

FIG. 2 illustrated a method 100 of connecting a processing-reporting unit 14 to a building local network 24 and wirelessly to a sensing unit 12 in accordance with an embodiment of the invention. Local network 24 is operating in the area where an energy meter system 10 is installed. Processing-reporting unit 14 attempts to connect to and maintain a connection to Wi-Fi network 114 and, in step 112, also creates a second sensor network 26 that may be an ad hoc Wi-Fi network. Sensor network 26 may implement security using a serial number and a password to ensure that only a paired sensing unit 12 is able to join the network. The processing-reporting unit 14 and the sensing unit 12 may be paired at the factory or through an installation or configuration process with matching serial number(s) or cryptographic keys to enable the sensing unit 12 to authenticate and connect to the sensor network 26. In step 116, sensing unit 12 connects to sensor network 26. Once operational, in step 118, sensing unit 12 may send pressure, temperature and RSSi readings to the processing-reporting unit 14. It may also transmit serial numbers and other sensor data. This data may be collected every 0.5 seconds and transmitted to the processing-reporting unit 14 every 2 seconds. In step 114, processing-reporting unit 14 will attempt to connect to building local network 24 in order to communicate with server 16, mobile device 20, or computer 18. If local network 24 is not available, in step 120 processing-reporting unit 14 will store data locally for local data collection via a direct connection to mobile device 20, or until a connection to local network 24 becomes available at a later time. In step 122, if local network 24 is available, processing-reporting unit 14 may connect to the network using credentials, such as a password, that has been configured. Configuration of network credentials may be done using an app running on mobile device 20. In step 124, the processing-reporting unit 14 compiles its own flow and temperature data as well as data received from sensing unit 12. The processing-reporting unit 14 may perform energy calculations internally and store sensor data and calculated values in an internal non-volatile memory (such as an EEPROM, flash memory, solid-state disk, or hard disk) in the processing-reporting unit 14. In step 126, the processing-reporting unit 14 will periodically send updated data or compiled information to the server 16. In some cases, the period is once every 5 seconds, but the period may be adjusted appropriately for individual installations. In step 128, server 16 stores received data from each sensor or calculated values for later use, data manipulation, and statistical analysis. In step 130, an app on mobile device 20 or a program on computer 18 may connect to server 16 directly or through an online portal, dashboard, or through the use of an API to retrieve data or use a billing service to bill tenants or users for their energy use.

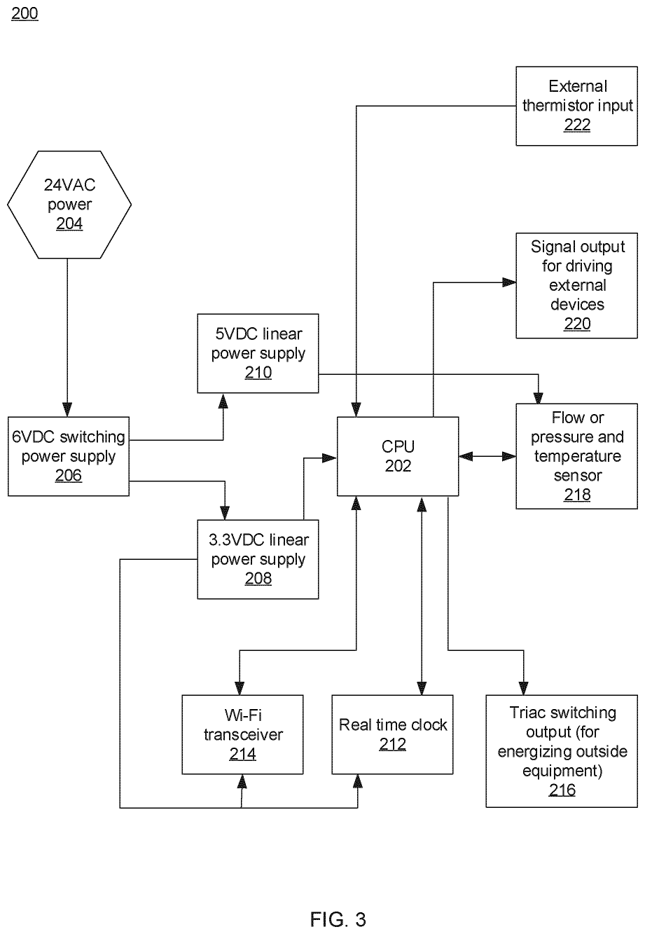

FIG. 3 illustrates a block diagram of a computing device 200 that may be used, modified, or customized to implement networked processing-reporting unit 14 or sensing unit 12 in accordance with an embodiment of the invention. 24 VAC power 204 is received externally. This is converted to a switching power supply 206 to produce a 6 VDC output. Linear power supply 210 converts this to a 5 VDC supply and linear power supply 208 converts the 6 VDC supply to a 3.3 VDC supply. The 5 VDC supply 210 and 3.3 VDC supply 208 are used to power the electronic components of the device depending on the requirements of each component. CPU 202 may be a microcontroller with internal RAM and program ROM as well as input and output ports, analog to digital converters (ADC), digital to analog converters (DACs), networking modules, timers, etc. as is known in the art. The CPU's 202 ROM stores programs of computer instructions that when executed cause the CPU to execute the methods disclosed herein including connecting to local network 24, creating ad hoc sensor network 26 to communicate with sensing unit 12, receive sensor data, store the data locally within processing-reporting unit 14, computer energy and volume calculations, and transfer data and calculated results to server 16. Each block of computing device 200 may be implemented in one or more physical electronic devices and each block of computing device 200 may be integrated with any other blocks illustrated. Some blocks may be optional and additional blocks not illustrated may be included in processing-reporting unit 14 or sensing unit 12.

CPU 202 receives timing information from real time clock 212. CPU 202 also interfaces with Wi-Fi transceiver 214 to connect to local network 24 and sensor network 26. Wi-Fi transceiver 214 includes necessary hardware and any required firmware support to support the creation of ad hoc sensor network 26. CPU 202 is programmed to output signals to control triac switching output 216 to operate valves or pumps based on flow, temperature, and pressure trigger limits selected by the user for system balancing and to prevent system failure. CPU 202 interfaces with flow, pressure, and temperature sensor(s) 218 to configure and receive sensor readings. CPU 202 may receive temperature data from an external thermistor 222. CPU 202 may also output signals to drive other external devices 220.

Although the invention has been described with reference to certain specific embodiments, various modifications thereof will be apparent to those skilled in the art without departing from the spirit and scope of the invention. All such modifications as would be apparent to one skilled in the art are intended to be included within the scope of the following claims.

It will be appreciated that, although specific embodiments of the technology have been described herein for purposes of illustration, various modifications may be made without departing from the scope of the technology. The specification and drawings are, accordingly, to be regarded simply as an illustration of the invention as defined by the appended claims, and are contemplated to cover any and all modifications, variations, combinations or equivalents that fall within the scope of the present invention. In particular, it is within the scope of the technology to provide a computer program product or program element, or a program storage or memory device such as a magnetic or optical wire, tape or disc, or the like, for storing signals readable by a machine, for controlling the operation of a computer according to the method of the technology and/or to structure some or all of its components in accordance with the system of the technology.

Acts associated with the method described herein can be implemented as coded instructions in a computer program product. In other words, the computer program product is a computer-readable medium upon which software code is recorded to execute the method when the computer program product is loaded into memory and executed on the microprocessor of the wireless communication device.

Further, each operation of the method may be executed on any computing device, such as a personal computer, server, PDA, or the like and pursuant to one or more, or a part of one or more, program elements, modules or objects generated from any programming language, such as C++, Java, or the like. In addition, each operation, or a file or object or the like implementing each said operation, may be executed by special purpose hardware or a circuit module designed for that purpose.

Through the descriptions of the preceding embodiments, the present invention may be implemented by using hardware only or by using software and a necessary universal hardware platform. Based on such understandings, the technical solution of the present invention may be embodied in the form of a software product. The software product may be stored in a non-volatile or non-transitory storage medium, which can be a compact disk read-only memory (CD-ROM), USB flash disk, or a removable hard disk. The software product includes a number of instructions that enable a computer device (personal computer, server, or network device) to execute the methods provided in the embodiments of the present invention. For example, such an execution may correspond to a simulation of the logical operations as described herein. The software product may additionally or alternatively include number of instructions that enable a computer device to execute operations for configuring or programming a digital logic apparatus in accordance with embodiments of the present invention.

Although the present invention has been described with reference to specific features and embodiments thereof, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations or equivalents that fall within the scope of the present invention.

What is claimed is:

1. An energy meter apparatus for measuring energy use in a system having a fluid circulating there through, the apparatus comprising:
a sensing unit comprising a first temperature sensor configured to measure temperature of the fluid at a first boundary of the system;
a processing-reporting unit comprising a second temperature sensor configured to measure temperature of the fluid at a second boundary of the system; and
one or both of a flow sensor and a pressure sensor, the flow sensor configured to measure an amount of the fluid through the system and included in one of the sensing unit and the processing-reporting unit, and the pressure sensor configured to measure a pressure of the fluid flowing through the system and included in one of the sensing units and the processing-reporting unit;
wherein the processing-reporting unit is configured to establish and maintain a first communication channel for communication with the sensing unit; and
wherein the sensing unit is configured to report sensor measurements to the processing-reporting unit via the first communication channel.

2. The apparatus of claim 1, wherein the processing-reporting unit hosts a sensor network accessible by the sensing unit, the first communication channel being established over the sensor network.

3. The apparatus of claim 1 or 2, wherein the sensing unit comprises the pressure sensor, and the processing-reporting unit comprises the flow sensor.

4. The apparatus of any one of claims 1 to 3, wherein the sensing unit, or the processing-reporting unit, are configured to store a predetermined amount of measurement data in internal memory for later retrieval.

5. The apparatus of any one of claims 1 to 3, wherein the processing-reporting unit, is configured to store a predetermined amount of measurement data in internal memory for later retrieval.

6. The apparatus of any one of claims 1 to 5, wherein the processing-reporting unit is configured to communicate, via a second communication channel separate from the first communication channel with an external server or a mobile device.

7. The apparatus of any one of claims 1 to 6, wherein the second communication channel is established and maintained by a device separate from the processing-reporting unit.

8. The apparatus of any one of claims 1 to 7, wherein the first or the second communication channels operate over wireless networks according to:
a Wi-Fi protocol;
a digital wireless communication protocol;
a Bluetooth™ protocol;
a Zigbee™ protocol; or
a mobile telephony protocol.

9. The apparatus of any one of claims 1 to 8, wherein the first or second communication channel allows for concurrent communication by or with two or more sensors or devices at a time.

10. The apparatus of any one of claims 1 to 9, wherein the sensing unit and the processing-reporting unit are configured to communicate via the first communication channel when the sensing unit and the processing-reporting unit are placed apart.

11. A system comprising: the apparatus of any one of claims 1 to 10; the system further comprising
a server configured to communicate directly or indirectly with the processing-reporting unit to receive energy usage data therefrom.

12. The system of claim 11, wherein the server is further configured to provide energy usage data to a second computer system, the second computer system configured to generate billing information based on the energy usage data, or wherein the server is further configured to generate the billing information based on the energy usage data.

13. The system of claim 12, wherein the server is further configured to provide one or both of: usage data; and billing information to a consumer mobile device having an application thereon which, when operated, displays said energy usage data, billing information, or both.

14. The system of claim 13, wherein the application, when operated, further causes the consumer mobile device to communicate with the apparatus to receive the energy usage data directly therefrom.

15. A system comprising:
the apparatus of any one of claims 1 to 11; the system further comprising
a consumer mobile device having an application thereon which, when operated, configures the consumer mobile device to communicate with the apparatus to receive energy usage data therefrom.
